(19) United States
(12) Patent Application Publication
(10) Pub. No.: US 2010/0245299 A1
(43) Pub. Date: Sep. 30, 2010

(54) LIQUID CRYSTAL DISPLAY DEVICE

(76) Inventors: Sang-Soo Han, Seoul (KR); Nak-Jin Seong, Gyeongbuk (KR); Kyu-Man Lee, Gyeongbuk (KR); Jae-Seo Kim, Gyeongbuk (KR); Chul-Hyun Hwang, Daegu (KR)

Correspondence Address: MORGAN LEWIS & BOCKIUS LLP, 1111 PENNSYLVANIA AVENUE NW, WASHINGTON, DC, 20004, US

(21) Appl. No.: 12/641,971

(22) Filed: Dec. 18, 2009

(30) Foreign Application Priority Data
Mar. 30, 2009 (KR) 10-2009-26801

(51) Int. Cl. G09G 5/00

(52) U.S. Cl. 345/204

(57) ABSTRACT

The present invention relates a liquid crystal display device for saving a production cost.

The liquid crystal display device includes a liquid crystal display panel for displaying a picture, a printed circuit board for supplying a control signal to the liquid crystal display panel, and data Chip On Film packages positioned between the liquid crystal display panel and the printed circuit board, wherein each of the data Chip On Film packages includes a data drive integrated circuit for driving data lines of the liquid crystal display panel, an effective film package having the data drive integrated circuit mounted thereto formed as a non-effective region is removed from a base film, an output pad region formed at the effective film package bonded to the liquid crystal display panel, and an input pad region formed at the effective film package bonded to the printed circuit board having a width smaller than that of the output pad region.

### CROSS REFERENCE TO RELATED APPLICATION

This application claims the benefit of the Patent Korean Application No. 10-2009-26801, filed on Mar. 30, 2009, which is hereby incorporated by reference as if fully set forth herein.

### BACKGROUND OF THE DISCLOSURE

1. Field of the Disclosure

The present invention relates to liquid crystal display devices, and, more particularly, to a liquid crystal display device which enables to fabricate a data drive integrated circuit by Chip On Film COF without any additional process for saving a production cost.

2. Discussion of the Related Art

The liquid crystal display device displays a picture by controlling light transmissivity of liquid crystals having dielectric anisotropy by using an electric field. For this, the liquid crystal display device is provided with a liquid crystal display panel for displaying the picture, and a drive circuit for driving the liquid crystal display panel.

The liquid crystal display panel displays the picture as the light transmissivities of a matrix of liquid crystal cells are controlled in response to pixel signals. The drive circuit is provided with a gate drive unit for driving gate lines in the liquid crystal display panel, a data drive unit for driving data lines in the liquid crystal display panel, a timing control unit for controlling driving timing of the gate drive unit and the data drive unit, and a power unit for supplying power required for driving the liquid crystal display panel and the drive circuit. The data drive unit has a plurality of data drive integrated circuits D-IC, and the gate drive unit has a plurality of gate drive integrated circuits. Each of the integrated circuits is mounted on a base film by Chip On film COF, and electrically connected to the liquid crystal display panel by Tape Automated Bonding TAB. As another method, the integrated circuit may be mounted to the liquid crystal display panel directly by Chip On Glass COG.

Output pads of the base film having the data drive integrated circuit mounted thereto are electrically connected to the liquid crystal display panel, and output pads of the base film are electrically connected to a Printed Circuit Board PCB having the timing control unit and so on mounted thereto.

In the meantime, since a display region of a certain area is required for displaying the picture thereon in COG in which the data drive integrated circuit is mounted to glass of the liquid crystal display panel directly, there is a limitation on an area the data drive integrated circuit is mounted thereto. Therefore, since a related art COG requires more data drive circuits each having a density of integration lower than the COF, the related art COG involves in an increased production cost. Accordingly, studies for saving the production costs by replacing specific models fabricated in the related art COG with COF are proceeding actively. However, if it is intended to replace the COG with COF while keeping the liquid crystal display devices of the specific models as they are, there is a problem in that the PCB can not, but become larger. Though fabrication of a PCB of a new size does not require high cost, fabrication of peripheral components of a monitor of the liquid crystal display device, i.e., existing peripheral components, bezel or case member, and so on, again in conformity with the PCB of the new size requires an enormous cost.

### SUMMARY OF THE DISCLOSURE

Accordingly, the present invention is directed to a liquid crystal display device.

An object of the present invention is to provide a liquid crystal display device which can reduce a production cost by introducing COF to a liquid crystal display device of an existing model of COG while keeping a size of a printed circuit board as it is.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a liquid crystal display device includes a liquid crystal display panel for displaying a picture, a printed circuit board for supplying a control signal to the liquid crystal display panel, and data Chip On Film packages positioned between the liquid crystal display panel and the printed circuit board, wherein each of the data Chip On Film packages includes a data drive integrated circuit for driving data lines of the liquid crystal display panel, an effective film package having the data drive integrated circuit mounted thereto formed as a non-effective region is removed from a base film, an output pad region formed at the effective film package bonded to the liquid crystal display panel, and an input pad region formed at the effective film package bonded to the printed circuit board having a width smaller than that of the output pad region.

The base film includes a cutting line which defines the effective film package, and a plurality of sprocket holes in the non-effective region arranged perpendicular to a width direction of the output pad region positioned on left/right sides of the output pad region and the input pad region, respectively.

The input pads in the input pad region have a pitch of 0.27 mm.

The liquid crystal display device further includes a gate drive integrated circuit of GIP (Gate Drive-IC in panel) type formed at the liquid crystal display panel directly for supplying a gate signal to a gate line of the liquid crystal display panel.

The effective film package has “an inverted T shape” or “an inverted trapezoid shape”.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates a diagram of a liquid crystal display device in accordance with a preferred embodiment of the present invention, schematically.

FIG. 2a illustrates a diagram showing a structure in which a data integrated circuit is fabricated by COG, FIG. 2b illustrates a diagram showing a structure in which a data integrated circuit is fabricated by COF by using the printed circuit board used in FIG. 2a, and FIG. 2c illustrates a diagram showing a structure in which a data integrated circuit is fabricated by COF in accordance with a preferred embodiment of the present invention.

FIG. 3 illustrates a base film including a data COF package in FIG. 1 or 2c.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

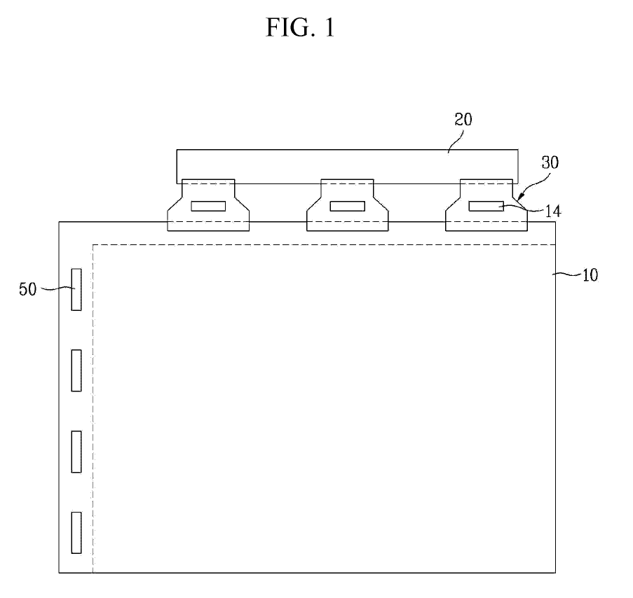

FIG. 1 illustrates a plan view of a liquid crystal display device in accordance with a preferred embodiment of the present invention.

Referring to FIG. 1, the liquid crystal display device includes a liquid crystal display panel 10 for displaying a picture, and a drive circuit for driving the liquid crystal display panel. The drive circuit includes a gate drive unit for driving gate lines in the liquid crystal display panel 10, a data drive unit for driving data lines in the liquid crystal display panel 10, a timing control unit for controlling driving timing of the gate drive unit and the data drive unit, and a power unit for supplying power required for driving the liquid crystal display panel 10 and the drive circuit. The data drive unit has a plurality of data drive integrated circuits 14, and the gate drive unit has gate drive integrated circuits 50 of a GIP (Gate Drive-IC in panel) type formed on the liquid crystal display panel 10, directly.

The liquid crystal display panel 10 has a thin film transistor array substrate, a color filter array substrate bonded together with liquid crystals disposed therebetween. The liquid crystal display panel has liquid crystal cells defined as the gate lines and the data lines cross each other, and each of the liquid crystal cells has a thin film transistor which is a switching device. The thin film transistor supplies a pixel signal from the data line to the liquid crystal cell in response to a scan signal from the gate line.

The data drive integrated circuit 14 is connected to the data line of the liquid crystal display panel 10 and the PCB 20 through a data COF package 30, electrically. The data drive integrated circuit 14 converts a digital pixel data from the timing controller at the PCB 20 into an analog pixel signal, and supplies the analog pixel signal to the data line.

The GIP gate drive integrated circuit 50, connected to the gate line at the liquid crystal display panel 10, supplies a turn on voltage to the thin film transistor in a scan period, and a turn off voltage to the thin film transistor in the other period.

The data COF package 30 has a plurality of input pads respectively connected to input pins of the data drive integrated circuit 14, and a plurality of output pads respectively connected to output pins. Input pads of the data COF package 30 is electrically connected to the PCB 30 by TAB, and output pads of the data COF package 30 is electrically connected to the liquid crystal display panel 10 by TAB. Herein, a region where the input pads are positioned is called as “an input pad region” in the data COF package 30, and a region where the output pads are positioned is called as “an output pad region” in the data COF package 30.

In the present invention, the data COF package 30 has a width of the input pad region formed smaller than a width of the output pad region. As a result of this, the data COF package 30 has an “inverted T” shape or an “inverted trapezoid” shape.

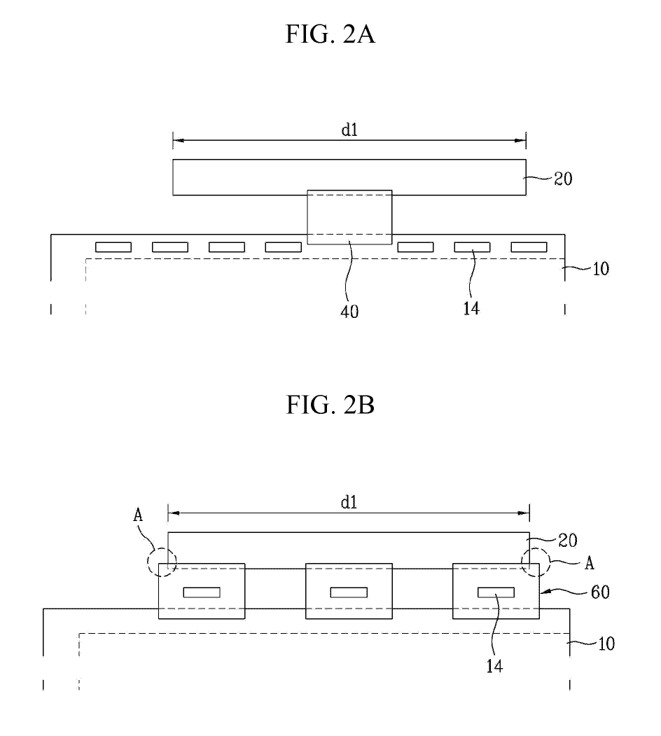

A purpose of forming the data COF package 30 to be the “inverted T” shape or the “inverted trapezoid” shape in the present invention will be described in detail, with reference to FIGS. 2a to 2c.

FIG. 2a illustrates a diagram showing a portion of the liquid crystal display device fabricated by COG.

Referring to FIG. 2a, the liquid crystal display device fabricated by COG includes a data drive integrated circuit 14 mounted on glass of the liquid crystal display panel 10, the PCB 20 and the liquid crystal display panel 10 connected to each other with an FPC (Flexible Printed Circuit) 40.

Since the liquid crystal display device fabricated by COG is required to have a display region of a certain area for displaying a picture, to require more data drive integrated circuits of low density integration, the liquid crystal display device fabricated by COG causes a problem of production cost increase. However, as shown in FIG. 2B, if it is intended to replace the liquid crystal display device of a specific model fabricated by related art COG with COF, regular bonding of the COF package is not possible.

In more detail, if it is intended to apply COF to the liquid crystal display device of a specific model fabricated by related art COG, the PCB 20 can not but become larger. This is because an adequate space is required between adjacent COF packages for regular connection of the output pads of the COF package and the data lines at the liquid crystal display panel 10. However, if it is intended to change from COG to COF while maintaining the liquid crystal display device of a specific model fabricated by related art COG, the PCB becomes larger, and fabrication of peripheral components, case and so on, of a monitor of the liquid crystal display device, again in conformity with the PCB of the new size requires an enormous cost. As shown in FIG. 2B, If a PCB of a size used in COG is used for using the present peripheral components as they are, portions (A regions) of the data COF package 60 positioned on outermost sides can not be bonded with the PCB 20.

Eventually, referring to FIG. 2c, a width of an input pad region of the data COF package 30 is reduced to a size smaller than the output pad region, enabling to introduce COF to the liquid crystal display device of a specific model fabricated by related art COG. In FIGS. 1 and 2c, the data COF package 30 has an “inverted T” shape, or an “inverted trapezoid” shape.

According to this, referring to FIGS. 2a and 2c, COF can be introduced to the liquid crystal display device of a specific model fabricated by related art COG without any additional fabrication while maintaining a length d1 and a size of the PCB 20 are kept the same as before. As a result of this, the production cost of the liquid crystal display device can be saved as models fabricated by the related art COG can be replaced with COF which has a low production cost while maintaining production of the models fabricated by the related art COG.

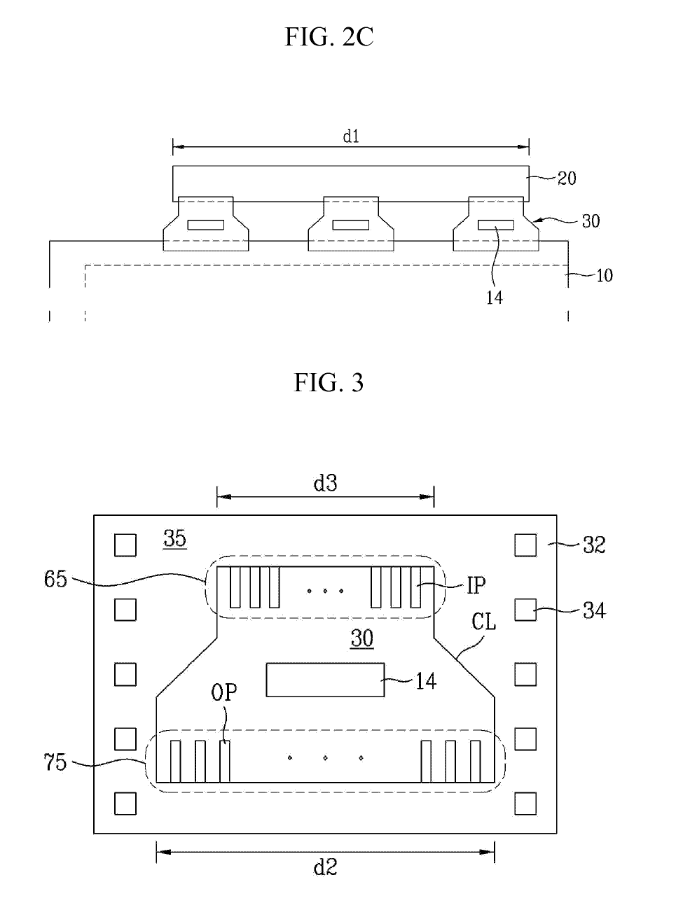

A detailed structure of the data COF package 30 shown in FIG. 1 and a base film cutting process provided to the data COF package 30 will be described with reference to FIG. 3.

FIG. 3 illustrates a base film 32 including a data COF package 30 in FIG. 1 or 2c before being cut. The base film in FIG. 3 has an effective film package 30 the same with the data COF package 30 in FIG. 1 and a non-effective region 35 to be removed in a cutting process.

Though the effective film package 30 is the same with the data COF package 30 in FIG. 1, the effective film package is called so for making it distinctive from the non-effective region 35. Accordingly, the effective film package 30 has the data drive integrated circuit 14 mounted thereto, the output pad region 75 to be bonded with the liquid crystal display panel 10 and the input pad region 65 to be bonded to the PCB 30 and having a width d3 smaller than a width d2 of the output pad region 75.

The input pins (not shown) of the data drive integrated circuit 14 are connected to a plurality of input pads IP, and the output pins (not shown) of the data drive integrated circuit 14 are connected to a plurality of output pads OP.

The non-effective region 35, to be removed in the cutting process along a cutting line CL, has a plurality of sprocket holes 34 arranged perpendicular to a width direction of the output pad region 75 positioned on left/right sides of the output pad region 75 and the input pad region 65, respectively. The sprocket holes 34 are used for transferring and fixing a transfer position of the base film 32.

If the base film 32 is cut following the cutting line CL, the effective film package 30 having the width d3 of the input pad IP region 65 smaller than the width d2 of the output pad OP region 75, i.e., the data COF package 30 can be obtained.

In this instance, in order to make the width of the input pad IP region 65 to be smaller than the width of the output pad OP region 75, a number of related art input pads IP are minimized.

For an example, a number of the output pads OP is the same with the output pads OP of the related art general data COF, and most of the plurality of the dummy pads of the input pads IP positioned at the outermost sides are removed, leaving only one on each side. The dummy pads, provided for preventing the input pads IP of the data COF package 30 suffering from damage, can protect the input pads IP adequately even if only one dummy pad exists at each of the outermost sides of the input pad IP region 65, actually. And, of pads connected to the input pins of the data drive integrated circuit 14, a number of LVDS (Low Voltage Differential Signals) pins are reduced from 6 pairs to 3 pairs, and a number of a plurality of ground pins and clock pins are minimized, to minimize a number of pins (or input pads) from 125 in the related art to 85. Along with this, a pitch of the input pads is minimized to 0.27 mm to minimize the width of the input pad region 65. Moreover, a width of the data COF 30 is formed to become the greater as the width goes from the input pad region 65 to the output pad region 75 of the base film 32 the more.

Thus, the liquid crystal display device of the present invention can minimize the width of the input pad region 65 of the effective film package 30 by minimizing a number of the input pads IP of the effective film package 30. According to this, COF can be introduced to the liquid crystal display device of an existing model of COG while maintaining a size of the PCB 20 as it is. As a result of this, the production cost of the liquid crystal display device can be saved as models fabricated by the related art COG can be replaced with COF which has a low production cost while maintaining production of the models fabricated by the related art COG.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A liquid crystal display device comprising:
a liquid crystal display panel for displaying a picture;
a printed circuit board for supplying a control signal to the liquid crystal display panel; and
data Chip On Film packages positioned between the liquid crystal display panel and the printed circuit board,
wherein each of the data Chip On Film packages includes;
a data drive integrated circuit for driving data lines of the liquid crystal display panel,
an effective film package having the data drive integrated circuit mounted thereto formed as a non-effective region is removed from a base film,
an output pad region formed at the effective film package bonded to the liquid crystal display panel, and
an input pad region formed at the effective film package bonded to the printed circuit board having a width smaller than that of the output pad region.

2. The liquid crystal display device as claimed in claim 1, wherein the base film includes;
a cutting line which defines the effective film package, and
a plurality of sprocket holes in the non-effective region arranged perpendicular to a width direction of the output pad region positioned on left/right sides of the output pad region and the input pad region, respectively.

3. The liquid crystal display device as claimed in claim 1, wherein the input pads in the input pad region have a pitch of 0.27 mm.

4. The liquid crystal display device as claimed in claim 1, further comprising a gate drive integrated circuit of GIP (Gate Drive-IC in panel) type formed at the liquid crystal display panel directly for supplying a gate signal to a gate line of the liquid crystal display panel.

5. The liquid crystal display device as claimed in claim 1, wherein the effective film package has “an inverted T shape” or “an inverted trapezoid shape”.
